(19) United States
(12) Patent Application Publication
(10) Pub. No.: US 2017/0208976 A1
(43) Pub. Date: Jul. 27, 2017

(54) Durable Ceramic Flatware

(71) Applicant: Certine LLC, Portland, ME (US)

(72) Inventors: David Muise, New Gloucester, ME (US); Rachel Rodrigues, Cumberland Foreside, ME (US); William Todd, Cumberland Foreside, ME (US)

(73) Assignee: Certine LLC, Portland, ME (US)

(21) Appl. No.: 15/398,498

(22) Filed: Jan. 4, 2017

Related U.S. Application Data
(60) Provisional application No. 62/286,724, filed on Jan. 25, 2016.

(51) Int. Cl. A47G 21/02; B26B 3/02; C04B 35/48; A47G 21/04

(52) U.S. Cl. CPC A47G 21/02; A47G 21/023; A47G 21/04; B26B 3/02; C04B 35/48; C04B 2235/3246; C04B 2235/3225; C04B 2235/3206

(57) ABSTRACT

Disclosed are durable ceramic flatware utensils and utensil sets as well as methods of making the same. The utensils are preferably manufactured from stabilized or partially stabilized zirconia with yttria or magnesium used as a dopant. The improved ceramic flatware may or may not take the form of multipurpose hybrid utensils or forks embodying one of several durability features.

### RELATED APPLICATIONS

The present application claims priority to U.S. Provisional Application No. 62/286,724 also entitled “Durable Ceramic Flatware” and filed Jan. 25, 2016, the content of which is hereby incorporated by reference.

### BACKGROUND OF THE INVENTION

Field of the Invention

The present invention relates generally to the field of ceramic flatware utensils and flatware sets and more specifically to ceramic fork, spoon, and knife utensils and sets incorporating the same.

Description of the Related Art

Metal flatware is made from silver alloy or other metals but is most commonly stainless steel. Such products are relatively durable and economical to manufacture and so they are found in most dining environments.

However, conventional metal flatware poses several disadvantages. When placed in the mouth of a person having dental work, a metal fork or spoon may cause considerably irritation. Metal utensils are also quick to become hot or cold and may feel uncomfortable to diners particularly if the utensils have become scratched or nicked. Furthermore, metal flatware in prolonged contact with certain foods is known to speed oxidation and sometimes imparts a perceived “sour flavor” when delivering food items to the mouth.

Ceramic materials have been accepted for use in the manufacture of knife type utensils. Knives made from ceramic materials are widespread and hold their edge significantly longer than comparable metal knives. Ceramics are also known to provide a potential non-abrasive, chemically and electrically inert, non-stick and non-stain surface. However, the brittle nature of ceramic materials has prevented them from being widely adopted for producing fork and spoon type utensils and complete flatware sets.

Utensils of the present invention represent durable ceramic flatware utensils that improve upon conventional metallic flatware. In addition to being chemically and electrically inert, utensils of the present invention are less prone to sticking and scratching and are more resistant to fracturing than ceramic utensils known in the prior art.

### SUMMARY OF THE INVENTION

The present invention is directed to durable flatware utensils and utensil sets including knives, forks, and spoons having durable ceramic head portions. The utensils are one continuous piece having uniform ceramic material throughout or the utensils are comprised of two or more pieces, combining separate head and handle portions. Utensils of the present invention have the advantage of being fracture resistant while still providing the advantages of a ceramic material.

In one aspect of the present invention ceramic utensils are engineered to perform in rigorous flatware applications. In a preferred embodiment, a fork type utensil comprises a zirconia ceramic head portion adapted for piercing food. The fork is made fracture resistant by a pair of curvatures imparted to the sides of the fork head and a convex alignment of the distal ends of its tines.

In other embodiments, a fork type utensil of the present invention is made still more fracture resistant by further engineering of the tines. To resist forces that come from impacts and intended uses of the fork utensil, outer tines are tapered so that their widths are substantially greater at the base. Preferably, the tine length to tine base width ratio is not more than about 5:1. In other embodiments, tines are also rounded at their distal ends to help distribute forces and resist chipping or fracturing at the ends of the tines. In still other embodiments, spaces between the tines are scalloped at the palm to reduce the tendency for developing fractures near the bases of the tines.

In another aspect of the present invention flatware utensils comprise durable ceramic materials. Preferably, the utensils are made of a stabilized or partially stabilized zirconia ceramic that is resistant to fracturing. In one embodiment, zirconium dioxide (ZrO₂), also known as zirconia, is stabilized by adding a stabilizing dopant to zirconium dioxide during the manufacturing process. The dopant is preferably yttrium oxide (Y₂O₃), also known as yttria, or magnesium oxide (MgO). After the addition of dopant, the zirconia is made into a slurry before molding, sintering, and polishing. The process produces durable zirconia ceramic utensils formed in a single uniform piece.

In an alternate embodiment, a similarly doped zirconia slurry is used to make only the head portion of a particular utensil and the head is attached to a handle after the polishing step. To facilitate attachment with the handle, the head portion of the utensil is provided with a tang at the proximate end that is shaped for joining securely with a suitable handle.

As with conventional metal flatware, utensils of the invention are made in various shapes and sizes. For example, spoons or forks are made large or small depending on the intended application. However, in another aspect of the present invention, ceramic flatware utensils are engineered as hybrids for multi-purpose use. In some embodiments, a spoon having a yttria or magnesium stabilized or partially stabilized zirconia head portion is engineered as a hybrid of a teaspoon, tablespoon, and soup spoon. The shape and circumference of the head portion is similar to a traditional teaspoon while the spoon has a deeper bowl to serve as a tablespoon or soup spoon when needed.

In other embodiments of the invention hybrid forks are also shaped and sized for multipurpose use and flatware sets incorporating hybrid spoons and forks are provided with a lesser number of utensils. In one embodiment, a set of zirconia ceramic flatware is comprised of a knife, a hybrid fork, and a hybrid spoon as an alternative to a five piece set.

### BRIEF DESCRIPTION OF THE DRAWINGS

FIG. 1 is a partial perspective view of a head portion of a conventional fork.

FIG. 2 is an overhead view of a ceramic fork utensil manufactured from stabilized zirconia.

FIG. 3 is an overhead view of a head portion of a zirconia ceramic fork utensil.

FIG. 4 is a partial perspective view of a ceramic fork head showing the distal ends of the inner tines.

FIG. 5 is an overhead view of a head portion of an improved ceramic fork.

FIG. 6 is an overhead view of a head portion of an improved ceramic spoon.

### DETAILED DESCRIPTION OF THE INVENTION

The present invention will be herein described with reference to accompanying drawings. The embodiments shown and described are intended to be exemplary and not construed as limiting. To be sure, it is intended that features of the various exemplary embodiments also be combined or interchanged to a greater or lesser degree as is suitable for other ceramic flatware embodiments.

The following are definitions of some of the terms used herein to describe numerous features of the present invention. Unless otherwise specified, the terms are intended to have their broadest possible meaning within the requirements of the law. As used throughout this specification:

The term “circumference” when used to describe a rim of a spoon is intended to be reasonably applied to any spoon type utensil as a comparable measure of size whether or not a particular spoon comprises a rim which completely encircles its bowl.

The term “fracture resistant” is intended to mean various lesser or greater degrees of improved fracture toughness including that which is gained by stabilizing or partially stabilizing a zirconia ceramic.

The term “mole percentage”, abbreviated “mole %” means the mole fraction ratio of one or more constituents in the mixture over the total constituents in the mixture multiplied by 100.

The term “rim” when used to describe a feature of a spoon means the edge of the spoon bowl and should be understood to include more or less the width of the stem attachment to the bowl if needed to measure or compare the size of the rim in terms of circumference.

The term “stabilized” when referring to the effect of a dopant on zirconia is intended to include various degrees of stabilization including fully or partially stabilized.

The term “utensil” as used herein is intended as a shorthand for an eating utensil or to similarly connote a flatware piece that would logically be provided as part of a flatware set.

Utensils of the present invention include knives, forks, and spoons made from or having at least a ceramic head portion that is preferably made from stabilized or partially stabilized zirconia. The ceramic head portion has a distal end that is formed to carry out specialized contact functions of flatware utensils according to their type. The functions of cutting, piercing, and containing a volume of liquid to maneuver a particular food item for eating are provided by the knife, fork, and spoon type utensils of the present invention respectively. The ceramic head portions of the fork and spoon utensils enhance the dining experience by eliminating metal to mouth contact.

Although ceramic spoons and knives are potentially subject to fracturing, ceramic fork utensil are the most vulnerable.

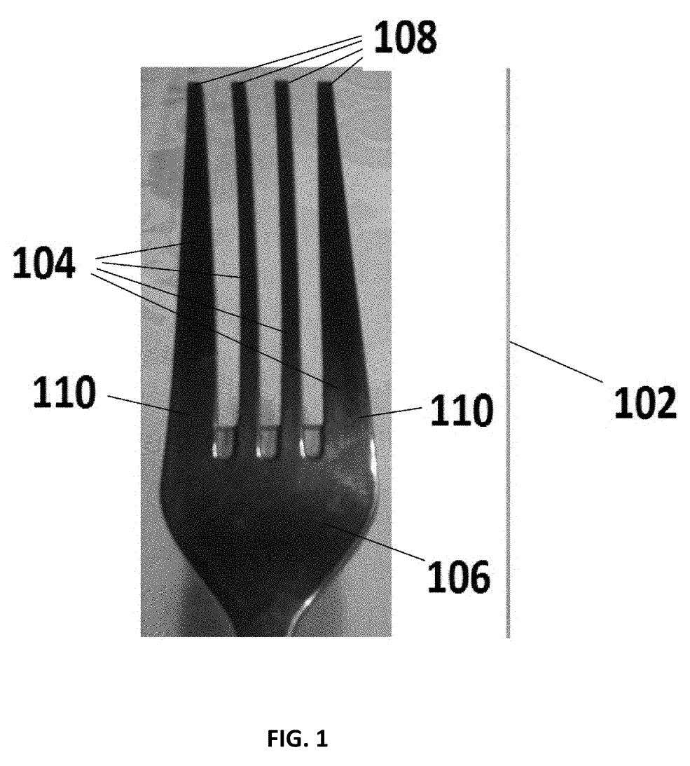

Shown in FIG. 1 is a head portion 102 of a fork having a conventional design. The fork includes tines 104 that are gradually tapered as they extend from the palm 106 of the fork head 102. The sides of the tines are straight and distal ends 108 of the four tines 104 are aligned in a straight line. While the shape of the fork head 102 is suitable for traditional flatware, the design would be prone to fail during use if the head portion 102 was simply made of ceramic. For instance, cutting through food with the side of the fork would impose significant force on an outer tine 110. The straight sides and brittle nature of ceramic would allow the outer tine bearing the force to fracture from the fork at the palm 106. Similarly, if the fork was dropped from table height to land on a hard surface the fork would be vulnerable to fracturing if either of the outer tines absorbed a significant amount of force.

Preferred embodiments of the present invention are herein specified to comprise partially stabilized zirconia because the stabilized ceramic material has been found to possess improved flexural strength and fracture resistance due to transformation toughening. However, tests have shown that even improved fracture resistance ceramics are prone to failure when combined with a fork head portion that is conventionally designed.

### Example 1—Drop Test of Conventionally Designed Ceramic Fork

25 ceramic fork heads were dropped on a ceramic tile floor from a height of 36 inches. The fork heads were made from yttria partially stabilized zirconium, each head having four equal length tines approximately 4.6 cm long. Being of conventional design, the tines tapered slightly toward distal ends that terminated in a straight line. Each fork head weighed approximately 18.4 grams and had outer tines that were 0.65 centimeters wide at their base.

The heads were dropped such that the tines would make initial contact with floor and then examined after every drop. Heads that didn't fracture were used up to three times.

88% of the conventionally designed ceramic fork heads failed during the drop test. The outer tines of the fork heads fractured at a significantly higher rate than did the inner tines or the palm of the head. Of those heads that failed, 77% demonstrated fractures to one of the outer tines. The fracture point of the outer tines was, in each case of failure, at or below the mid-point of the tine, toward the palm of the fork. The fracture point of the inner tines was, in each case of failure, at the junction of the tine and the palm. Shown below in Table 1 are the recorded results of the drop test.

TABLE 1
36 Inch Drop Test for Zirconia Fork Heads

| | Drop 1 | Drop 2 | Drop 3 |
|---|---|---|---|
| Fork Head # | Failures | Failures | Failures |
| 1 | outer tine | | |
| 2 | outer tine | | |
| 3 | no failure | no failure | outer tine |
| 4 | outer tine | | |
| 5 | no failure | no failure | no failure |
| 6 | outer tine | | |
| 7 | no failure | outer tine | |
| 8 | no failure | no failure | outer tine |
| 9 | no failure | no failure | no failure |
| 10 | outer tine | | |
| 11 | no failure | no failure | outer tine |
| 12 | no failure | outer tine | |
| 13 | no failure | no failure | inner tine |
| 14 | no failure | palm | |
| 15 | outer tine | | |
| 16 | no failure | no failure | inner tine |
| 17 | outer tine | | |
| 18 | outer tine | | |
| 19 | inner tine | | |
| 20 | outer tine | | |
| 21 | no failure | no failure | no failure |
| 22 | no failure | no failure | inner tine |
| 23 | outer tine | | |
| 24 | outer tine | | |
| 25 | no failure | no failure | outer tine |

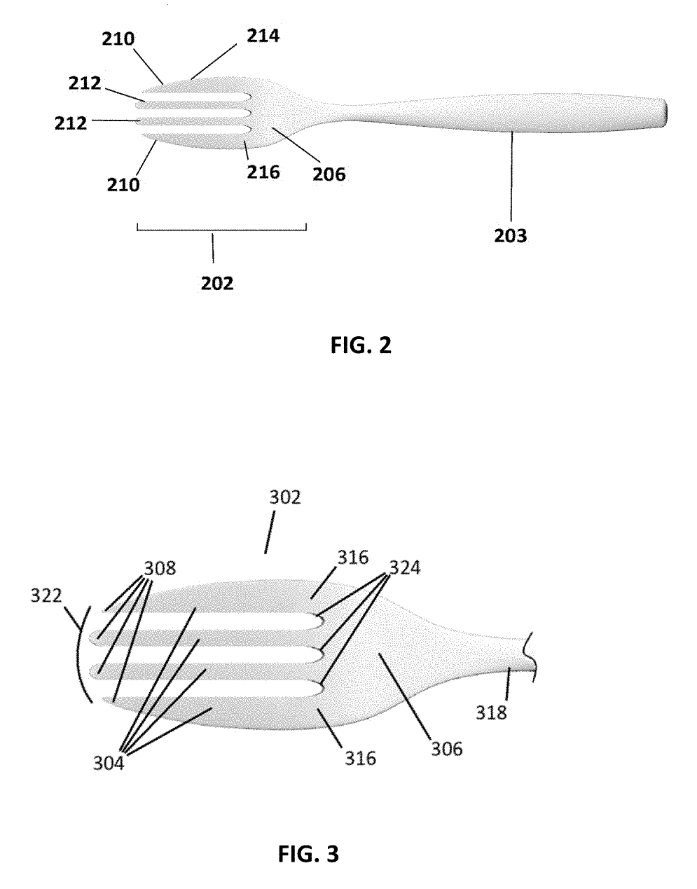

Shown in FIG. 2 is a fork type utensil embodiment of the present invention. The fork includes a head portion and a handle of durable ceramic in one continuous piece and is further engineered with features that improve the fracture resistance of the fork.

The utensil of FIG. 2 is a hybrid between a traditional dinner fork and a salad fork with two inner and two outer tines. The two inner tines 212 are longer and represent the length and food piercing capability of a traditional dinner fork. The shorter outer tines 210 assist scooping and small portion eating. The outside edge 214 of the fork is rounded for levered cutting and the outer tines 210 are wide at the base 216 to prevent the fork from failing in the event the utensil is dropped.

Shown now in FIG. 3 is a larger view of the head portion of the fork utensil of FIG. 2. As shown in FIG. 3, the head 302 comprises a stem 318 at the proximate end that widens to an adjacent palm 306. At the opposite end of the palm are four tines 304 adapted for specialized contact with food items. The tines 304 are spaced apart from one another and in the same plane. Each of the tines begins at a base 316 adjacent to the palm 306 and extends for a length toward a distal end 308. The outermost tines are slightly shorter than the innermost tines so that the distal ends 308 of the tines are in a convex alignment 322.

The convex alignment 322 of the tines has been found to result in a more durable ceramic fork. If the fork is dropped on a hard surface the resulting force is more likely to be distributed across multiple tines, rather than being absorbed by a single tine and potentially fracturing one of the outer tines at the base. Still referring to FIG. 3, scallops 324 in the palm 306 at the spaces between the tines 304 also reduce the tendency for developing fractures.

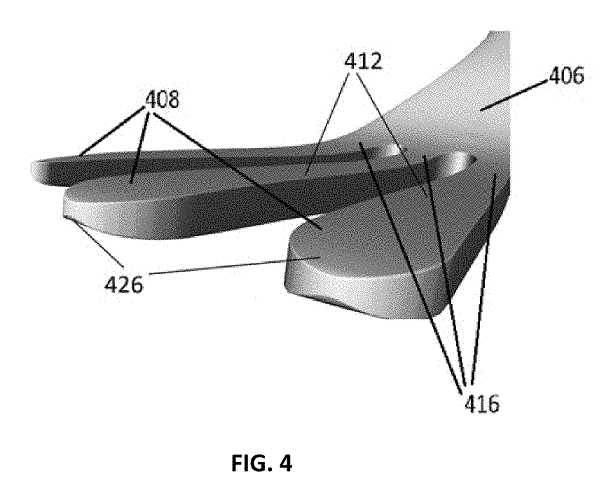

Shown in FIG. 4 are three of four tines of a ceramic fork embodiment of the present invention. Each of the tines has a base 416 and a distal end 408. The inner tines 412 of the fork are formed with rounded distal ends 408 and chamfers 426 making the tines resistant to chipping. Each tine is elongate, spanning between a distal end 408 and a base 416, beyond which it merges with the other tines of the fork to form the palm 406.

Utensils of the present invention are preferably made of stabilized or partially stabilized ceramic zirconia. Stabilization improves the physical, chemical, and electrical properties of the zirconia ceramic, making it more fracture resistant. Stabilized zirconia flatware may be made by combining various dopants with zirconia powder. Preferred dopants for the purpose of stabilizing zirconia ceramic flatware include but are not limited to magnesium oxide (MgO) and yttrium oxide also known as yttria (Y₂O₃), or a mixture of both.

In preferred embodiments, powdered zirconium dioxide (ZrO₂) is blended with a lesser amount of powered diyttrium trioxide (Y₂O₃) and/or magnesium oxide (MgO) powder as stabilizing dopants prior to sintering. The amount of dopant in the powdered mixture may be between 2 and 9 mol % but is preferably between 3 and 6 mol % if using only yttria (Y₂O₃). The powdered mixture is combined with liquid to produce a slurry that is injection molded into utensil shaped cavities under many tons of pressure. The molded slurry material is then sintered in a kiln to produce a stabilized ceramic utensil. After sintering, the utensil is polished to give a smooth finish. In other embodiments, the zirconia ceramic is stabilized by other dopants to a greater or lesser degree as is known in the art.

In one embodiment, ceramic zirconia is stabilized with only yttria as a dopant. To manufacture a fork, powdered zirconium dioxide is blended with a lesser amount of yttrium oxide powder, between 2 and 9 mol %. The powdered mixture is combined with water to produce a slurry that is injection molded into a forked shaped cavity under high pressure as is known in the art. After being removed from the mold, the molded material is sintered in a kiln at high temperature. After sintering, the relatively rough ceramic utensil is polished in a tumbler to give a smooth finish. In preferred embodiments, the amount of yttrium oxide to zirconium oxide is between 3 and 6 mol %.

In another embodiment, zirconia powder is again milled together with yttria. The resulting powder is then formed into a slurry and injected into spoon shaped molds. The molded material is then sintered for 32 hrs. at 1450 degrees Celsius. After sintering, the utensils are polished to a fine luster. In still other embodiments, sintering takes place in two stages for up to 72 hours. First, at 800 degrees Celsius to stabilize dopant, then at 1450 degrees Celsius to stabilize zirconia.

Utensils of the present invention may alternatively be constructed of multiple pieces, with a ceramic head portion attached to a non-ceramic handle. In some embodiments, multi-piece construction reduces the cost of certain utensils and in other embodiments provides additional options for aesthetic and ergonomic design. Handles for multi-piece utensils are made from a variety of materials including but not limited to traditional flatware material, such as stainless steel, silver alloy, plastic, wood, or the like.

In some multi-piece embodiments, the connection of the handle to the head portion is made more secure by incorporation of one or more notches, nubs, or voids along the tang. In a preferred embodiment, the tang of a ceramic fork head includes both elongated and round voids over which plastic is molded. The handle of the utensil is manufactured by positioning the stem of the fully finished head portion inside a mold. Liquid plastic is directed into the mold around the stem to fill the voids of the tang and allowed to set. After the plastic has sufficiently hardened the utensil is removed from the mold having a handle that is securely attached the stem. Notched, nubbed, or voided tangs may alternatively be employed with different handle materials to pin or otherwise attach handles to ceramic head portions. In some embodiments, a two part epoxy is used together with or instead of the notches, nubs, or voids. Suitable plastics for handles include ABS or polypropylene and the like.

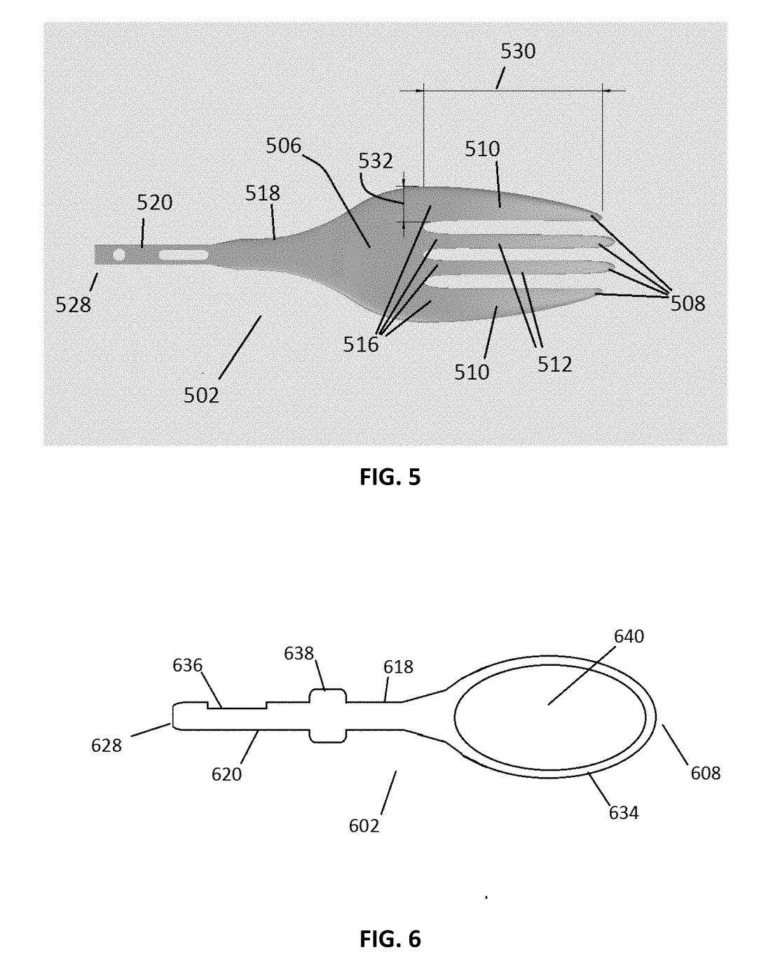

Shown now in FIG. 5 is a head portion 502 of a fork utensil according to one embodiment of the present invention. The head portion 502 is elongate, having a tang 520 at its proximate end 528. The tang 520 extends from an adjacent stem 518 that widens to form a palm 506 at a central part of the head portion 502. The tang 520 includes two voids; one oblong and the other a round bore. The voided tang 520 may be joined with an over molded plastic handle alone or the voids may be used to receive a pin or rivet that helps to secure a handle to the tang 520. Opposite the stem 518, adjacent to the palm 506 are four parallel tines which project from the palm 506 for a length 530 and terminate at distal ends 508.

Referring to the invention in general, preferred fork embodiments of the invention include outer tines that are abruptly tapered so that their widths are substantially greater at the base, to withstand forces that result from accidental impacts as well as intended uses. It has been found that the tine length to tine base width ratio should be less than about 7:1. Preferably, the tine length to tine base width ratio is about 5:1 or less.

Referring again to FIG. 5, the head comprises two inner tines 512 and two outer tines 510. The inner tines 512 are slightly longer than the outer tines 510, providing convex alignment of the distal ends 508 to help resist fractures. Further, the outer tines 510 are abruptly tapered, having a length 530 of approximately 36 millimeters and a base 516 that is approximately 7.2 millimeters in width 532. Although the outer tines 510 are generally wider than the inner tines 512, all tines are about 1.5 millimeters thick along the entire length 530, from base 516 to distal end 508.

In another aspect of the present invention, ceramic spoon utensils are engineered as hybrids for multi-purpose use. In one hybrid spoon embodiment of the present invention, the handle and head portions of a spoon are formed in one continuous piece from zirconia ceramic. The ceramic head portion of the multipurpose spoon is adapted to contain a volume of liquid and shaped and sized as a teaspoon except that the depth of the spoon bowl is deeper than a conventional teaspoon so as to contain a greater volume. As such, the spoon may be used for a wider variety of purposes than a conventionally proportioned teaspoon, including those applications which would otherwise call for a desert spoon or a tablespoon. Preferably the volume of liquid that can be contained by the multipurpose spoon is between 8 and 12 milliliters.

In another embodiment, a two piece spoon is engineered as a hybrid of a teaspoon, tablespoon, and soup spoon, as shown in FIG. 6. The head portion of the spoon is manufactured from yttria or magnesium stabilized or partially stabilized zirconia for fracture resistance according to the present invention. The head includes a distal end 608 and a proximate end 628. At the proximate end 628 is a tang 620 extending from a stem 618 to be connected with a plastic handle. Along the tang 620 is a notch 636 and a nub 638 to help stabilize the connection. The spoon is referred to as a hybrid because the rim 634 has a shape and circumference similar to a traditional teaspoon but the spoon has a deeper bowl 640 to also serve as a soup spoon or dessert spoon when needed.

With the handle attached (not shown), the notch 636 and nub 638 keep the head portion 602 from slipping out of the handle cavity, as the over-molding itself keeps the head firmly in place, prohibiting lateral movement.

Ceramic forks and spoons of the present invention need not be engineered as hybrids and may instead be sized and shaped for providing a single function, having more or less of a conventional design. For instance in some embodiments, dinner forks are designed with large heads having three tines. Similarly, teaspoons embodiments are sized with conventional rim circumferences and have bowls that hold no more than about 5.0 mls. of liquid. However, when hybrid flatware pieces are included in a set, the number of utensils in the set may be advantageously minimized.

In accordance with the present invention, ceramic utensils of the fork and spoon type are provided in flatware sets for eliminating metal to mouth contact. In some embodiments, zirconia utensils are constructed in two pieces, with ceramic head portions fixed on handles similar to handles of other utensil included in the set. In other embodiments one piece zirconia ceramic utensils having continuous ceramic head and handle portions of the same material are included with other two piece ceramic utensils in a set. In other embodiments all utensils of a set are one piece stabilized or partially stabilized zirconia ceramic. Preferably, sets of zirconia ceramic flatware include hybrid forks and multipurpose spoons to reduce the number of utensils in the set.

In one embodiment a yttria stabilized or partially stabilized zirconia flatware set is comprised of a knife, a hybrid fork, and a hybrid spoon. The three utensils perform the function of a traditional five piece flatware set, conserving costly ceramic material and requiring less space for storage.

In another embodiment, a ceramic flatware set is comprised of a medium sized knife, a hybrid fork, and a hybrid spoon as an alternative to a five piece set. In still another embodiment, a zirconia stabilized ceramic flatware set is comprised of five pieces with each utensil engineered for a single purpose.

We claim:

1. An improved ceramic flatware utensil comprising:
an operative head portion for maneuvering food items, the head portion having a proximate end and a distal end, with the distal end adapted for specialized contact with said food items;
and an elongated handle portion extending from the proximate end of the head portion for manipulating the utensil, the head portion being manufactured by sintering a mixture of zirconium oxide powder with at least one stabilizing dopant from the group consisting of i) a magnesium oxide and ii) a yttrium oxide, whereby the ceramic of the head portion is made fracture resistant by the addition of the stabilizing dopant.

2. The ceramic flatware utensil of claim 1 wherein the amount of the stabilizing dopant added to the zirconium oxide powder is between 3 and 6 mol %.

3. The ceramic flatware utensil of claim 1 wherein the handle portion is continuous with the proximate end of the head portion and manufactured from the same material.

4. The ceramic flatware utensil of claim 1 wherein the type of utensil is selected from the group consisting of a knife, a fork, and a spoon.

5. The ceramic flatware utensil of claim 4 wherein the utensil is a fork having a head portion adapted for piercing food further comprising:
elongated tines separated by spaces at the distal end of the head portion, said tines including outer tines and inner tines merging at one end to form a palm between the tines and the proximate end of the head portion, said outer tines being wider than said inner tines to resist fracturing.

6. The ceramic flatware utensil of claim 4 wherein the utensil is a fork having a head portion adapted for piercing food further comprising:
elongated tines separated by spaces at the distal end of the head portion, said tines including outer tines and inner tines merging at one end to form a palm between the tines and the proximate end of the head portion, said outer tines having a length to width ratio of no more than approximately 5:1 to resist fracturing.

7. The ceramic flatware utensil of claim 4 wherein the utensil is a fork having a head portion adapted for piercing food further comprising:
elongated tines separated by spaces at the distal end of the head portion, said tines including outer tines and inner tines merging at one end to form a palm between the tines and the proximate end of the head portion, wherein the palm is scalloped at the spaces between the tines to resist fracturing.

8. The ceramic flatware utensil of claim 4 wherein the utensil is a fork having a head portion adapted for piercing food further comprising:
elongated tines separated by spaces at the distal end of the head portion, said tines including outer tines and inner tines merging at one end to form a palm between the tines and the proximate end of the head portion, wherein the distal ends of the inner tines are rounded to resist fracturing.

9. The ceramic flatware utensil of claim 4 wherein the utensil is a fork having a head portion adapted for piercing food further comprising:
elongated tines separated by spaces at the distal end of the head portion, said tines including outer and inner tines merging at one end to form a palm between the tines and the proximate end of the head portion, and wherein the inner tines extend further at the distal end of the head portion than the outer tines thereby forming a convex alignment of projecting tines to resist fracturing.

10. The ceramic flatware utensil of claim 4 wherein the utensil is a spoon having a head portion with a rim shape and circumference typical of a teaspoon and adapted to contain a volume of liquid food item, wherein the volume of the head portion is between the range of 8 and 12 mls.

11. An improved ceramic flatware utensil comprising:
a fracture resistant ceramic head for maneuvering food items, the head portion having a proximate end forming a tang for attachment with a handle, a distal end adapted for specialized contact with said food items; and an elongated handle fixed to the tang for manipulating the utensil.

12. The ceramic flatware utensil of claim 11 wherein the tang further comprises one or more notches or voids along the tang to facilitate fastening to the handle.

13. The ceramic flatware utensil of claim 11 wherein the tang further comprises one or more nubs protruding laterally from along the tang to facilitate fastening to the handle.

14. The ceramic flatware utensil of claim 11 wherein the head and the handle are joined together with epoxy.

15. The ceramic flatware utensil of claim 11 wherein the handle is made of plastic that is molded over the tang.

16. A set of improved flatware utensils comprising:
a fork having a ceramic head portion extending from an elongated handle; and
a spoon having a ceramic head portion extending from an elongated handle, whereby use of the set avoids metal to mouth contact experienced with traditional metal flatware.

17. The set of improved flatware utensils of claim 16 wherein at least one of the ceramic utensils of the set is engineered for multi-purpose use, thereby eliminating the need for additional utensils.

18. The set of improved ceramic flatware utensils of claim 16 wherein at least one of the elongated handles of the set is made from a non-ceramic material that is fixed to the ceramic head portion of a utensil.

19. A set of improved flatware utensils of claim 16 further comprising:
a knife having a ceramic head portion extending from an elongated handle, wherein at least one of the elongated handles of the set is made from a non-ceramic material that is fixed to the ceramic head portion of a utensil.

20. The set of improved ceramic flatware utensils of claim 16 wherein the ceramic head portion of at least one of the utensils is zirconia that has been at least partially stabilized with a dopant selected from the group consisting of magnesium oxide and yttrium oxide, whereby the utensil is made fracture resistant by the addition of the dopant.
